(19) United States
(12) Patent Application Publication
(10) Pub. No.: US 2008/0197746 A1
(43) Pub. Date: Aug. 21, 2008

(54) Vehicle alternator with improved brush device

(75) Inventors: Hitoshi Wada, Fuwa-gun (JP); Hiroshi Ishida, Anjo-shi (JP)

Correspondence Address: OLIFF & BERRIDGE, PLC, P.O. BOX 320850, ALEXANDRIA, VA, 22320-4850, US

(73) Assignee: DENSO CORPORATION, KARIYA-CITY (JP)

(21) Appl. No.: 12/071,471

(22) Filed: Feb. 21, 2008

(30) Foreign Application Priority Data
Feb. 21, 2007 (JP) 2007-040194

(51) Int. Cl. H02K 13/00; H01R 39/40

(52) U.S. Cl. 310/242; 310/232; 310/247

(57) ABSTRACT

A vehicle alternator is disclosed having a stator, a rotor having a field winding, a rotary shaft formed with slip rings, and a field winding electrically connected to the slip rings, and a brush holder accommodating therein the brushes in sliding contact with the slip rings. The brush holder has first accommodating portions for accommodating therein brushes and second accommodating portions for accommodating therein spring members for urging the brushes against the slip rings in sliding contact therewith. A seal member is coupled to the brush holder in close proximity to sidewalls of the brushes so as to close opening portions of the first accommodating portions in positions facing the slip rings.

### CROSS REFERENCE TO RELATED APPLICATIONS

This application is related to Japanese Patent Application No. 2007-40194, filed on Feb. 21, 2007, the content of which is hereby incorporated by reference.

### BACKGROUND OF THE INVENTION

1. Technical Field of the Invention

The present invention relates to vehicle alternators and, more particularly, to a vehicle alternator adapted to be installed on a vehicle such as a passenger car, a truck or the like.

2. Description of the Related Art

In general vehicle alternators well known in the art, it has been a common practice to encompass a stator and a rotor, rotatably disposed inside the stator, in a housing wherein the rotor carries thereon cooling fans for generating cooling winds with a rotation of the rotor. The housing takes the form of a structure having discharge windows through which the cooling winds, generated by the cooling fans, are discharged to the outside. In addition, the rotary has a rotary shaft carrying thereon slip rings to be integrally rotatable. The housing carries thereon a rear cover that covers a brush holder, accommodating brushes held in sliding contact with the slip rings, and electrical component parts involving the brushes.

For the vehicle alternators of such a related art, attempts have heretofore been made to provide vehicle alternators with various structures. For instance, Japanese Utility Model Publication No. 62-41567 discloses a vehicle alternator including a brush holder having an end face formed with a mazy recessed configuration having a plurality of bend sections. U.S. Pat. No. 4,959,576 discloses a vehicle alternator having a brush holder and a rear cover between which a seal member is disposed in a structure having a cooling wind flow path. U.S. Pat. No. 5,424,600 discloses a vehicle alternator having a seal member formed with a mazy cooling wind flow path having a plurality of bend sections. U.S. Pat. No. 6,294,856 discloses a vehicle alternator including a brush holder formed with a concaved portion to which a part of a slip ring cover is inserted to provide a mazy structure.

The vehicle alternators of such related arts, described above, encounter environmental deterioration in use especially when installed on vehicles in a wide variety of installed conditions and installed on off-road vehicles, etc. In this case, there is a fear of foreign matters such as splashed mucky water droplets intruding an inside area of the rear cover accommodating the electrical component parts. The foreign matters penetrate an inside of the brush holder holding the brushes in sliding contact with the slip rings with actions of spring members. This causes the foreign matters to accumulate in the brush holder with age. This causes drops to occur in the spring members to urge the brushes with resultant poor electrical contacts between the brushes and the slip rings on a final stage. Thus, the vehicle alternator has deteriorated environmental resistance, causing an issue to arise with a degraded function to generate electric power. Therefore, a need has been arising to provide a vehicle alternator having a brush holder formed in a simplified structure to prevent the entry of foreign matters to the inside area of the brush holder for thereby providing improved environmental resistance.

### SUMMARY OF THE INVENTION

The present invention has been completed with a view to addressing the above issues and has an object to provide a vehicle alternator enabled to prevent the entry of foreign matters to an inside area of a brush holder even when installed in a wide variety of installed conditions for thereby providing improved environmental resistances of brushes under various vehicle environments.

To achieve the above object, one aspect of the present invention provides a vehicle alternator comprising: a stator having a stator winding; a rotor, having a field winding and rotatably disposed in the stator, which is mounted on a rotary shaft formed with slip rings electrically connected to the field winding; a brush holder having first accommodating portions for accommodating therein brushes and second accommodating portions for accommodating therein spring members for urging the brushes against the slip rings in sliding contact therewith; and a seal member coupled to the brush holder in close proximity to sidewalls of the brushes so as to close opening portions of the first accommodating portions in positions facing the slip rings. With such a structure, the vehicle alternator can be mounted on a vehicle in a wide variety of installed conditions under which foreign matters such as incurred water droplets are prevented from penetrating an inside of the brush holder. This provides improved environment resistance in a highly reliable manner.

Further, the seal member may be preferably made of flexible resin and held in slight contact with the brushes with given urging forces. This allows the brush holder to be formed in a simplified structure under which opening portions of the brush accommodating portions can be reliably sealed.

Further, the seal member may be preferably coupled to the brush holder on an outer periphery thereof. This enables the foreign matters from intruding through a clearance between the seal member and the brush holder, enabling the brushes to have improved environment resistances in a further reliable manner.

The vehicle alternator may further preferably comprise partitioning members interposed between the brushes and the spring members for partitioning the first and second accommodating portions from each other. With such a structure, even if the foreign matters intrude the first accommodating portion, the foreign matters can be completely avoided from penetrating the second accommodating portions in which the spring members are accommodated. This allows the brushes to have improved environment resistances in a highly reliable manner.

Another aspect of the present invention provides a vehicle alternator comprising: front and rear frames coupled to each other; a stator fixedly supported with the front and rear frames and having a stator winding; a rotor, having a field winding and rotatably disposed in the stator, which is mounted on a rotary shaft formed with slip rings electrically connected to the field winding; a brush holder carried on the rear frame and including a holder body formed with first accommodating portions having opening portions to accommodate therein brushes in moving capability and second accommodating portions for accommodating therein spring members in cooperation with the brushes for urging the brushes against the slip rings in sliding contact therewith; and a seal member coupled to the holder body so as to close the opening portions of the first accommodating portions in sliding contact with the brushes.

With such a structure, the vehicle alternator can be mounted on a vehicle in a wide variety of installed conditions under which foreign matters such as muddy water droplets are prevented from penetrating an inside of the brush holder. This allows the vehicle alternator to have highly improved environment resistance.

Another aspect of the present invention provides a vehicle alternator comprising: front and rear frames coupled to each other; a stator fixedly supported with the front and rear frames and having a stator winding; a rotor, having a field winding and rotatably disposed in the stator, which is mounted on a rotary shaft formed with slip rings electrically connected to the field winding; a brush holder carried on the rear frame and including a holder body formed with first accommodating portions having opening portions to accommodate therein brushes in moving capability and second accommodating portions for accommodating therein spring members in cooperation with the brushes for urging the brushes against the slip rings in sliding contact therewith, the holder body having an outer circumferential wall formed with a concaved portion; and a seal member including a side wall having an inner periphery formed with an inwardly protruding convexed portion held in coupling engagement with the concaved portion of the holder body to be coupled thereto for closing the opening portions of the first accommodating portions in sliding contact with the brushes.

With such a structure, even if the vehicle alternator is installed on a vehicle under various mounting conditions, no foreign matters enter the inside area of the brush holder. Thus, the vehicle alternator can have highly improved environment resistance.

A further aspect of the present invention provides a vehicle alternator comprising: front and rear frames coupled to each other; a stator fixedly supported with the front and rear frames and having a stator winding; a rotor, having a field winding and rotatably disposed in the stator, which is mounted on a rotary shaft formed with slip rings electrically connected to the field winding; a brush holder carried on the rear frame and including a holder body formed with first accommodating portions having opening portions to accommodate therein brushes in moving capability and second accommodating portions for accommodating therein spring members in cooperation with the brushes for urging the brushes against the slip rings in sliding contact therewith, the holder body having an outer circumferential wall formed with a concaved portion; a seal member including a side wall having an inner periphery formed with an inwardly protruding convexed portion held in coupling engagement with the concaved portion of the holder body to be coupled thereto for closing the opening portions of the first accommodating portions in sliding contact with the brushes; and partitioning members interposed between the brushes and the spring members in the holder body for partitioning the first and second accommodating portions from each other.

With the brush holder structured to close the opening portions of the first accommodating portions in sliding contact with the brushes, no foreign matter can enter the inside area of the brush holder. In addition, the partitioning members are disposed in the brush holder between the first and second accommodating portions. This prevents the foreign matters from penetrating the second accommodating portions in which the spring members are accommodated. Thus, no foreign matters accumulate in the second accommodating portions, thereby ensuring normal operations of the spring members for urging the brushes against the slip rings. This allows the vehicle alternator to reliably operate to generate electric power in a highly reliable manner for extended period of time.

### BRIEF DESCRIPTION OF THE DRAWINGS

FIG. 1 is a cross sectional view showing an overall structure of a vehicle alternator of an embodiment according to the present invention.

FIG. 2 is an enlarged fragmentary view showing a brush device incorporated in the vehicle alternator shown in FIG. 1.

FIG. 3 is an enlarged fragmentary view showing a detailed structure of a brush device incorporated in the vehicle alternator shown in FIG. 1.

### DETAILED DESCRIPTION OF PREFERRED EMBODIMENTS

Now, a vehicle alternator of an embodiment according to the present invention will be described below in detail with reference to the accompanying drawings. However, the present invention is construed not to be limited to such an embodiment described below and technical concepts of the present invention may be implemented in combination with other known technologies or the other technology having functions equivalent to such known technologies.

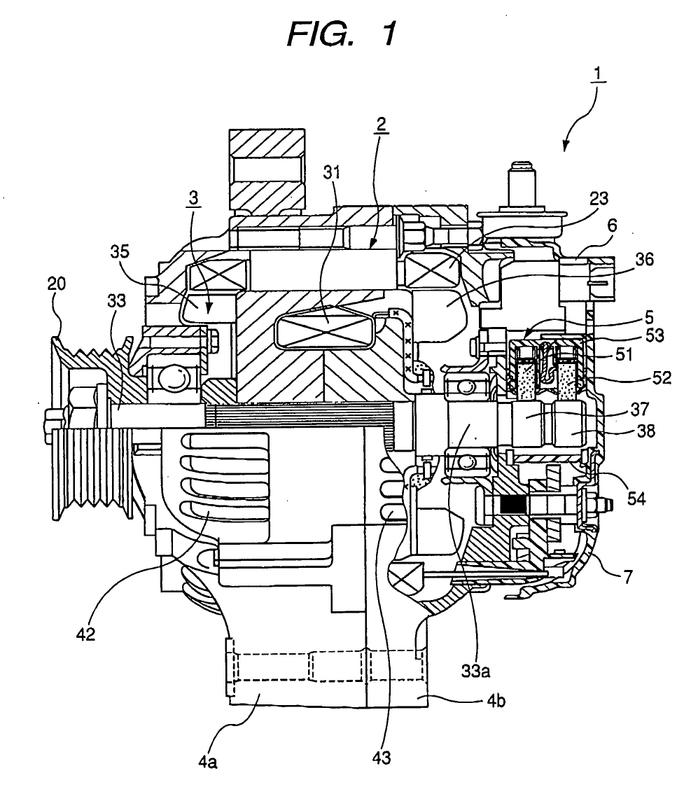

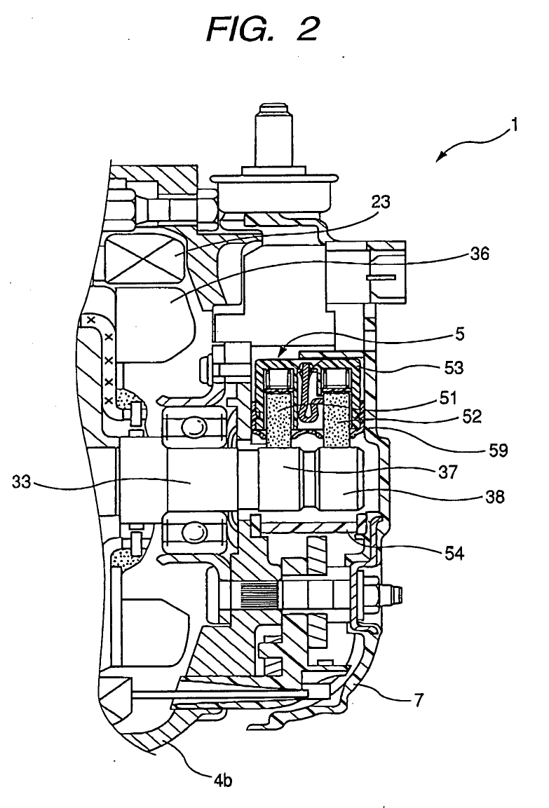

Hereunder, a vehicle alternator of an embodiment according to the present invention will be described below in detail with reference to the accompanying drawings. FIG. 1 is a cross sectional view showing the vehicle alternator of the present embodiment implementing the present invention. FIG. 2 is a fragmentary enlarged cross sectional view showing a major part of the vehicle alternator of the present embodiment.

As shown in FIG. 1, the vehicle alternator 1 includes a stator 2 on which an armature winding 23 is wound, a rotor 3 rotatably disposed in an inner circumferential periphery of the stator 2 to be placed radially inward in opposition thereto and carrying thereon a field winding 31, cooling wind generating means composed of cooling fans 35 and 36 mounted on the rotor 3 at axial end faces thereof for generating cooling winds during a rotation of the rotor 3, front and rear frames 4a and 4b between which the stator 2 and the rotor 3 are placed, a brush device 5 mounted on the rear frame 4b at a rear end face thereof for supplying a field current to the field winding 31, a voltage regulator 6 for controlling an output voltage at a given value, a rear cover 7 for covering electric component parts such as the brush device 5 and the voltage regulator 6, etc., to protect these component parts from being contaminated with foreign matters, and a pulley 20 for transmitting a rotational drive force from an engine (not shown) to the rotor 3.

The front housing 4a has a sidewall formed with a plurality of cooling wind discharge windows 42. The cooling wind discharge windows 42 serve to allow a centrifugal cooling wind, occurring in an area near the pulley 20 during the rotation of the cooling fan 35, to be discharged to an outside of the front housing 4a. In addition, the rear housing 4b has a sidewall formed with a plurality of cooling wind discharge windows 43. The cooling wind discharge windows 43 serve to allow a centrifugal cooling wind, occurring in an area near the rear cover 7 during the rotation of the cooling fan 36, to be discharged to an outside of the rear housing 4b.

The rotor 3 has a rotary shaft 33 having one axial end 33a to which slip rings 37 and 38 are fixed to be unitarily rotatable with the rotary shaft 33. The brush device 5 includes a brush holder 53 accommodating therein two brushes 51 and 52 held in sliding engagement with the slip rings 37 and 38, respectively, and a slip ring cover 54 covering outer circumferences of the brush holder 53 and slip rings 37 and 38.

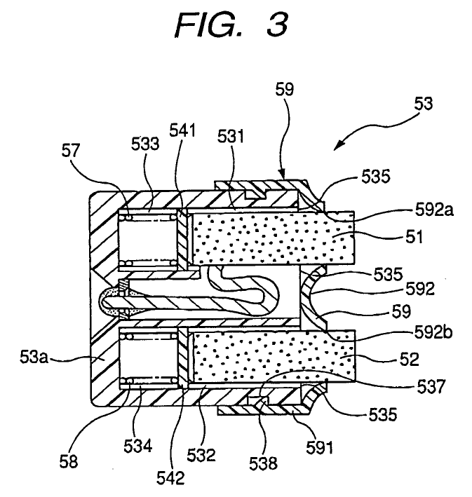

FIG. 3 is an enlarged cross sectional view showing a detailed structure of the brush holder 53.

The brush holder 53 includes a holder body 53a having first brush accommodating portions 531 and 532, in which the brushes 51 and 52 are accommodated, respectively, and second accommodating portions 533 and 534 for accommodating therein spring members 57 and 58, respectively, which urge the brushes 51 and 52 against the slip rings 37 and 38, respectively.

The holder body 53a of the brush holder 53 has one end to which a seal member 59 is fixedly secured in a position near sidewalls of the brushes 51 and 52 so as to close opening portions 535 of the first brush accommodating portions 531 and 532 in positions facing the slip rings.

The seal member 59, comprised of a single component part made of resin such as nylon or the like, takes the form of a box-like structure having a sidewall 591 and a bottom wall 592. The bottom wall 592 has two slide bores 592a and 592b through which the brushes 51 and 52 extend, respectively, in sliding engagement therewith.

The sidewall 591 of the seal member 59 has an inner circumferential wall formed with an inwardly protruding convexed portion 538. Meanwhile, the holder body 53a of the brush holder 53 has an outer circumferential wall, forming an outer profile of the brush holder 53, which is formed with an outwardly facing concaved portion 537 in a position adjacent to the inwardly protruding convexed portion 538. Bringing the convexed portion 538 of the seal member 59 into coupling engagement with the concaved portion 537 of the holder body 53a allows the seal member 59 to be coupled and fixed to the brush holder 53 to close the opening portions 535. With the seal member 59 held in such a coupled and fixed state, the seal member 59 is held in slight contact with the sidewalls of the brushes 51 and 52, extending through the bores 592a and 592b, respectively, at given urging forces. In addition, the convexed portion 538 may include plural convexed segments formed on the inner circumferential wall of the seal member at four circumferential surfaces, respectively, or include a single convexed segment formed on the inner circumferential wall of the seal member in an entire circumference thereof. Likewise, the concaved portion 537 may include plural concaved segments formed on the outer circumferential sidewall of the brush body 53a at four circumferential surfaces, respectively, which form an outer shell of the brush holder 53 or include a single convexed segment formed on the outer circumferential sidewall of the holder body 53a in an entire circumference thereof.

Further, with the vehicular alternator of the present embodiment, the brush holder 53 includes partition members 541 and 542 interposed between the brushes 51 and 52 and the spring members 57 and 58, respectively, for partitioning the first brush accommodating portions 531 and 532 and the second accommodating portions 533 and 534 from each other. The first and second accommodating portions 531 and 533 have the substantially same cross-sectional shapes (each normally in a squared cross-sectional shape). The partitioning member 541 has the substantially same shape as that of the second accommodating portion 533 and is used for filling a cross sectional area in the vicinity of a boundary between the first and second accommodating portions 531 and 533 with almost no clearance. The partitioning member 542 has a similar effect.

With the vehicular alternator 1 of the present embodiment, the seal member 92, placed in the vicinity of the brushes 51 and 52, covers the opening portions 533 of the first brush accommodating portions 531 and 532, opening in areas facing the slip rings, which accommodate therein the brushes 51 and 52. This allows the vehicular alternator 1 of the present embodiment to be installed in a wide variety of mount conditions. Under such an installed state, the seal member 59 can prevent foreign matters, such as water droplets or dusts, from intruding an inside area of the brush holder 53 when such foreign matters enter an inside of the vehicular alternator 1, thereby enabling the brushes 51 and 52 to have increased environmentally resistant property in a highly reliable manner.

Further, with the seal member 59 molded with resin having flexibility, the seal member 59 can be held in light contact with the brushes 51 and 52 with given urging forces in a simplified structure, which can reliably seals the opening portions 533 of the first brush accommodating portions 531 and 532 of the brush holder 53. In addition, coupling the inwardly protruding convexed portion 538, formed on the seal member 59 at the inner circumferential wall thereof, to the concaved portion 537, formed on the outer circumferential wall of the holder body 53a, enables the seal member 59 to be reliably coupled to the outer circumferential wall of the holder body 53a. This results in capability of preventing the entry of the foreign matters from the clearance between the seal member 59 and the holder body 53a, enabling the brush holder 53 to have increased environmentally resistant property in a further reliable manner.

Further, the partitioning members 541 and 542 are placed in areas between the first accommodating portions 531 and 532 and the second accommodating portions 533 and 534. With such a structure, even if the foreign matters intrude the first accommodating portions 531 and 532, the partitioning members 541 and 542 block the foreign matters from entering the second accommodating portions 533 and 534 in which the spring members 57 and 58 are accommodated. This allows the brush holder 53 to have increased environmentally resistant property in a further reliable manner.

While the present invention has been exemplarily described in detail with reference to the specific embodiment, the present invention is not limited to such an illustrated embodiment and may take various modifications. Although the vehicular alternator 1 has been described above as having the rear cover 7 made of resin, the rear cover 7 may be made of metallic materials such as aluminum and iron, etc.

While the vehicular alternator 1 of the present embodiment has been described above with reference to the structure including both of the seal member 59 and the partitioning members 541 and 542, either one of the seal member 59 and the partitioning members 541 and 542 may be employed and the other may be omitted. For instance, even with only the seal member 59 being employed, it becomes possible to prevent the foreign matters from intruding the brush holder 53 at the opening portions 533 thereof. Moreover, under a situation where only the partitioning members 541 and 542 are employed, even if the foreign matters enter the brush holder 53 at the opening portions 533 thereof, no foreign matter can reach the spring members 57 and 58.

Thus, the particular arrangement disclosed is meant to be illustrative only and not limited to the scope of the present invention, which is to be given the full breadth of the following claims and all equivalents thereof.

What is claimed is:

1. A vehicle alternator comprising:
a stator having a stator winding;
a rotor, having a field winding and rotatably disposed in the stator, which is mounted on a rotary shaft formed with slip rings electrically connected to the field winding;
a brush holder having first accommodating portions for accommodating therein brushes and second accommodating portions for accommodating therein spring members for urging the brushes against the slip rings in sliding contact therewith; and
a seal member coupled to the brush holder in close proximity to sidewalls of the brushes so as to close opening portions of the first accommodating portions in positions facing the slip rings.

2. The vehicle alternator according to claim 1, wherein:
the seal member is made of flexible resin and held in slight contact with the brushes with given urging forces.

3. The vehicle alternator according to claim 1, wherein:
the seal member has slide bores through which the brushes extend in sliding contact.

4. The vehicle alternator according to claim 1, further comprising:
partitioning members interposed between the brushes and the spring members for partitioning the first and second accommodating portions from each other.

5. The vehicle alternator according to claim 1, wherein:
the brush holder has an outer circumferential periphery formed with a concaved portion; and
the seal member has an inner circumferential periphery formed with inwardly protruding convexed portion in coupling engagement with the concaved portion of the brush holder.

6. A vehicle alternator comprising:
front and rear frames coupled to each other;
a stator fixedly supported with the front and rear frames and having a stator winding;
a rotor, having a field winding and rotatably disposed in the stator, which is mounted on a rotary shaft formed with slip rings electrically connected to the field winding;
a brush holder carried on the rear frame and including a holder body formed with first accommodating portions having opening portions to accommodate therein brushes in moving capability and second accommodating portions for accommodating therein spring members in cooperation with the brushes for urging the brushes against the slip rings in sliding contact therewith; and
a seal member coupled to the holder body so as to close the opening portions of the first accommodating portions in sliding contact with the brushes.

7. A vehicle alternator comprising:
front and rear frames coupled to each other;
a stator fixedly supported with the front and rear frames and having a stator winding;
a rotor, having a field winding and rotatably disposed in the stator, which is mounted on a rotary shaft formed with slip rings electrically connected to the field winding;
a brush holder carried on the rear frame and including a holder body formed with first accommodating portions having opening portions to accommodate therein brushes in moving capability and second accommodating portions for accommodating therein spring members in cooperation with the brushes for urging the brushes against the slip rings in sliding contact therewith, the holder body having an outer circumferential wall formed with a concaved portion; and
a seal member including a side wall having an inner periphery formed with an inwardly protruding convexed portion held in coupling engagement with the concaved portion of the holder body to be coupled thereto for closing the opening portions of the first accommodating portions in sliding contact with the brushes.

8. A vehicle alternator comprising:
front and rear frames coupled to each other;
a stator fixedly supported with the front and rear frames and having a stator winding;
a rotor, having a field winding and rotatably disposed in the stator, which is mounted on a rotary shaft formed with slip rings electrically connected to the field winding;
a brush holder carried on the rear frame and including a holder body formed with first accommodating portions having opening portions to accommodate therein brushes in moving capability and second accommodating portions for accommodating therein spring members in cooperation with the brushes for urging the brushes against the slip rings in sliding contact therewith, the holder body having an outer circumferential wall formed with a concaved portion;
a seal member including a side wall having an inner periphery formed with an inwardly protruding convexed portion held in coupling engagement with the concaved portion of the holder body to be coupled thereto for closing the opening portions of the first accommodating portions in sliding contact with the brushes; and
partitioning members interposed between the brushes and the spring members in the holder body for partitioning the first and second accommodating portions from each other.
